(19) United States
(12) Patent Application Publication
(10) Pub. No.: US 2016/0113061 A1
(43) Pub. Date: Apr. 21, 2016

(54) APPARATUS FOR THERMAL TREATMENT OF AN INNER SURFACE OF A TUBULAR OR OTHER ENCLOSED STRUCTURE

(71) Applicant: APPLIED LIGHT TECHNOLOGIES INC., Vancouver (CA)

(72) Inventor: Mladen Bumbulovic, Vancouver (CA)

(21) Appl. No.: 14/894,268

(22) PCT Filed: May 26, 2014
(86) PCT No.: PCT/CA2014/050494

§ 371 Date: Nov. 25, 2015

Related U.S. Application Data
(60) Provisional application No. 61/828,102, filed on May 28, 2013.

(51) Int. Cl. H05B 3/00; H05B 3/06

(52) U.S. Cl. CPC H05B 3/0061; H05B 3/06

(57) ABSTRACT

A heat treatment apparatus for heat treating an interior surface of a longitudinally extending cavity of a target structure has a processing head which comprises a longitudinally extending central support member and distal and proximal end caps protruding laterally from the central support member. Each end cap has a plurality of apertures configured to respectively receive distal and proximal ends of elongated plasma arc lamps and position the plasma arc lamps to extend longitudinally along and laterally around the central support member such that radiation emitted collectively by the plasma arc lamps is directed generally radially outwards from the processing head. The processing head also comprises a coolant pathway having heat exchange zones in thermal communication with the plasma arc lamps and coolant supply and return conduits in fluid communication with the heat exchange zones.

### CROSS-REFERENCE TO RELATED APPLICATIONS

This application claims priority to U.S. Provisional Patent Application No. 61/828,102 filed May 28, 2013, the contents of which are hereby incorporated by reference. This application also claims priority to U.S. patent application Ser. No. 14/090,885 filed Nov. 26, 2013, the contents of which are hereby incorporated by reference.

### TECHNICAL FIELD

The present disclosure relates generally to an apparatus for thermally treating an inner surface of an enclosed structure such as a pipe.

### BACKGROUND

Thermal treatment is commonly performed on inner surfaces of pipes and other enclosed structures to improve certain mechanical characteristics of the structure, such as increased corrosion resistance and surface strength. For example, a cladding or coating can be deposited onto the inner surface of a pipe and bonded to the pipe through application of heat from a high intensity heating source. Known high intensity heating sources suitable for such thermal treatments include welding torches, high power laser emitters, and electrical tungsten filament heaters. Known welding torches and laser emitters are only capable of treating relatively small portions of an inner surface at a time, thereby causing the thermal treatment to be relatively slow and inefficient. Electrical tungsten filament heaters are typically bulky and incapable of heat treating inner surfaces of enclosed structures having small cavities, such as small diameter pipes.

A plasma arc lamp has been proposed as a heat source for thermally treating pipes and other enclosed structures. In particular, PCT application PCT/US2012/028655 to Sherman et al. discloses an apparatus comprising a single infrared plasma arc lamp that is mounted inside a reflector enclosure having a heat discharge opening that directs heat produced by the plasma arc lamp towards a part of a pipe's inner surface. Like other known pipe thermal treatment techniques, the apparatus disclosed Sherman et al. can only treat a relatively small portion of a pipe surface at a time, resulting in a slow and inefficient thermal treatment process.

### SUMMARY

According to one aspect of the invention, there is provided a heat treatment apparatus for heat treating an interior surface of a longitudinally extending cavity of a target structure. The heat treatment apparatus has a processing head which comprises a longitudinally extending central support member, and distal and proximal end caps protruding laterally from the central support member. Each end cap has a plurality of apertures configured to respectively receive distal and proximal ends of elongated plasma arc lamps and position the plasma arc lamps to extend longitudinally along and laterally around the central support member such that radiation emitted collectively by the plasma arc lamps is directed generally radially outwards from the processing head. The processing head also comprises a coolant pathway having heat exchange zones in thermal communication with the plasma arc lamps and coolant supply and return conduits in fluid communication with the heat exchange zones.

The heat treatment apparatus can further comprise a coolant distribution assembly coupled to the processing head and comprising a coolant supply conduit in fluid communication with the coolant supply conduit of the processing head, and a coolant return conduit in fluid communication with the coolant return conduit of the processing head. A connector can be provided that releasably couples the processing head to the coolant distribution assembly.

The target structure can be a cylindrical pipe in which case the plurality of apertures of the distal and proximal end caps are configured in a circular array such that the plasma arc lamps extend laterally around the central support member in a circular array. More particularly, the plurality of apertures of the distal and proximal end caps can be evenly spaced around the circular array. Even more particularly, the distal and proximal end caps can each comprise at least three apertures for receiving at least three plasma end caps.

The processing head can further comprise a plurality of flow tubes that are each mounted to and extend between the end caps and around one plasma arc lamp. Each heat exchange zone is an annular channel defined by an interior surface of a flow tube and the exterior surface of a plasma arc lamp inside the flow tube. At least one of the flow tubes can comprise a reflective coating positioned to reflect radiation generated by the plasma arc lamp inside the at least one flow tube in a radial outwards direction from the processing head.

The coolant supply conduit can extend through the central support member, in which case the coolant pathway further comprises a coolant supply manifold inside the distal end cap and in fluid communication with an outlet end of the coolant supply conduit and an inlet end of each of the annular channels, and a coolant discharge manifold inside the proximal end cap and in fluid communication with an outlet end of each of the annular channels and the coolant return conduit.

### BRIEF DESCRIPTION OF THE DRAWINGS

In the accompanying drawings, which illustrate one or more exemplary embodiments:

FIG. 1 is a perspective view of a heat treatment apparatus according to one embodiment and having a coolant distribution assembly and a processing head coupled at a proximal end to the coolant distribution assembly;

FIG. 2(a) is a perspective view of the processing head comprising a support and cooling subassembly and an array of plasma arc lamps mounted inside flow tubes of the support and cooling subassembly;

FIGS. 2(b)-(c) are assembled and exploded perspective views of the support and cooling subassembly;

FIG. 2(d) is a longitudinally sectioned view of a portion of the processing head located inside a pipe;

FIGS. 2(e)-(f) and are perspective and distal end views of components of the support and cooling subassembly, and FIG. 2(g) is a longitudinally sectioned view of same taken along line A-A shown in FIG. 2(f);

FIG. 2(h)-(j) are cross-sectional, distal end and proximal end views of the processing head;

FIGS. 3(a)-(c) are perspective and front end views of the coolant distribution assembly wherein FIG. 3(b) is an enlarged view of a distal end of the coolant distribution assembly as encircled in FIG. 3(a).

FIG. 3(d) is a longitudinally sectioned view of the coolant distribution assembly.

FIG. 4 is a longitudinally sectioned view of a portion of the heat treatment apparatus showing the interconnection between the processing head and the coolant distribution assembly.

### DETAILED DESCRIPTION

Directional terms such as “proximal”, “distal”, “longitudinal”, and “lateral” are used in the following description for the purpose of providing relative reference only, and are not intended to suggest any limitations on how any article is to be positioned during use, or to be mounted in an assembly or relative to an environment.

The embodiments described herein are directed towards a heat treatment apparatus for thermally treating one or more inner surfaces of an elongated cavity of a target structure, and in particular an inner surface of tubular and other enclosed structures having a longitudinally extending cavity. One application where the embodiments can be useful is in bonding a coating onto an inner surface of a pipe. The heat treatment apparatus comprises a processing head having an array of high intensity heat lamps such as plasma arc lamps as a heat source; the plasma arc lamps are arranged lengthwise (i.e. longitudinally) on the processing head to allow the plasma arc lamps to be positioned lengthwise in the longitudinally-extending cavity of an enclosed structure when the processing head is inserted into the cavity. Further, the plasma arc lamps are positioned laterally around a central support member of the processing head in a configuration that generally follows the cross-sectional contour of the target cavity and which allows the plasma arc lamps to collectively emit radiation in a generally radial direction from the processing head. In one embodiment, the heat treatment apparatus is configured to heat treat tubular structures having cylindrical cavities (e.g. cylindrical pipes), and has an array of plasma arc lamps arranged in a longitudinally-extending manner and in a circumferentially spaced lateral configuration that follows the circular cross-section of a cylindrical cavity and allows each plasma arc lamp to be positioned in relatively close proximity to the inner surface of the cylindrical cavity. This configuration should allow the processing head to treat the entire cylindrical cavity at one time when the length of the cavity is less than or equal to the length of the plasma arc produced by the lamps, since the processing head can heat treat around the entire circumference of the cylindrical cavity at one time. This is expected to reduce processing time and improve efficiency. For cylindrical cavities that are longer than the length of the plasma arc, the processing head can treat the cylindrical cavity in lengthwise sections, wherein the processing head and cylindrical cavity are translated relative to each other along a longitudinal axis; again.

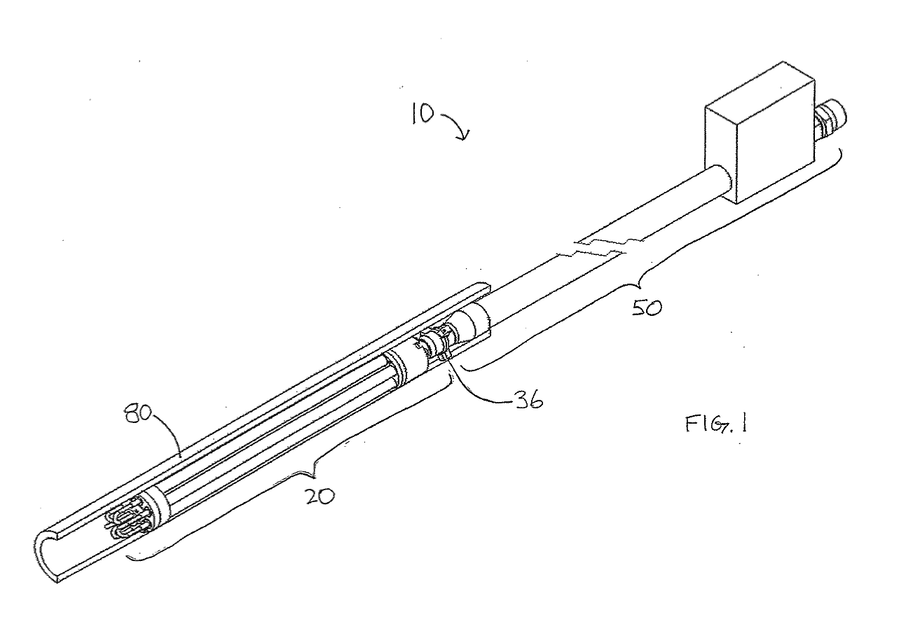

Referring to FIG. 1 and according to one embodiment, a heat treatment apparatus 10 is configured particularly to heat treat enclosed tubular structures having a cylindrical cavity such as a cylindrical pipe 80, although it can also be used to heat treat enclosed structures having non-cylindrical longitudinal cavities. The heat treatment apparatus 10 comprises two major components, namely, a processing head 20 comprising a plurality of plasma arc lamps 12 for heating an inner surface of the enclosed structure and a coolant distribution assembly 50 for mechanically supporting and supplying a coolant to the processing head 20. The processing head 20 is physically coupled to the coolant distribution and support assembly 50 by a mechanical connector 36. The coolant can be deionized water or another suitable (electrically non-conductive) liquid coolant as is known in the art.

The processing head 20 has a generally elongated shape, and in particular has a cross-sectional profile which is configured to allow the processing head 20 to translate within the target cavity of the enclosed structure along its longitudinal axis; in this embodiment the processing head 20 has a generally circular cross-sectional profile with a diameter that is smaller than the inner diameter of the cylindrical pipe 80. The pipe 80 can be fixed in place by a mount (not shown), and a translation device (not shown) such as a wheeled cart can support the apparatus 10 and move the processing head 20 relative to the pipe 80 along the longitudinal axis of the pipe 80. Alternatively, the apparatus 10 can be fixed to a mount (not shown), and the pipe 80 can be mounted on a translation device (not shown) that can move the pipe 80 relative to the processing head 20 along the longitudinal axis of the pipe 80.

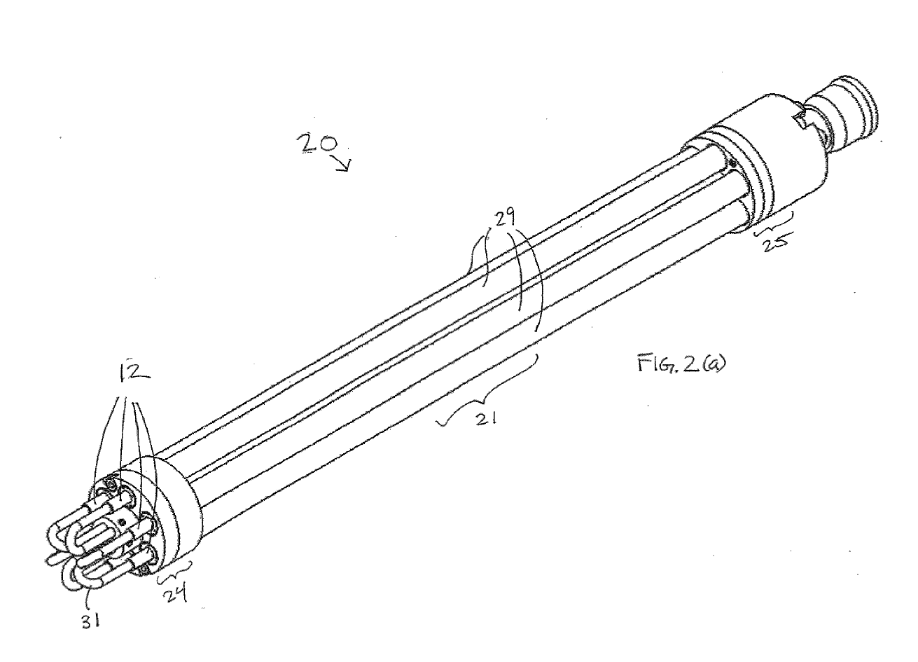

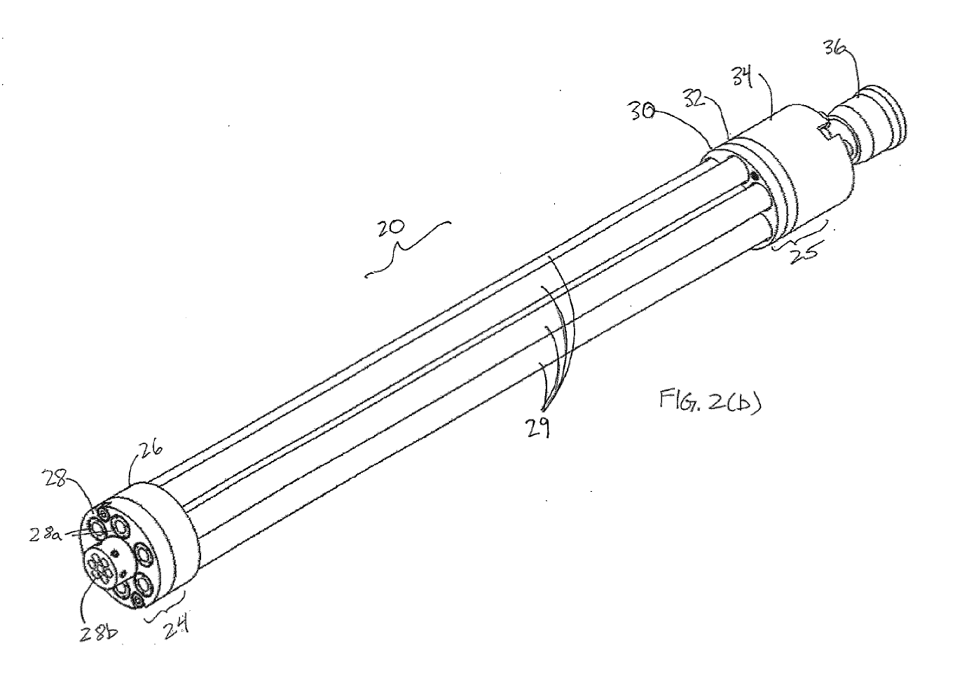

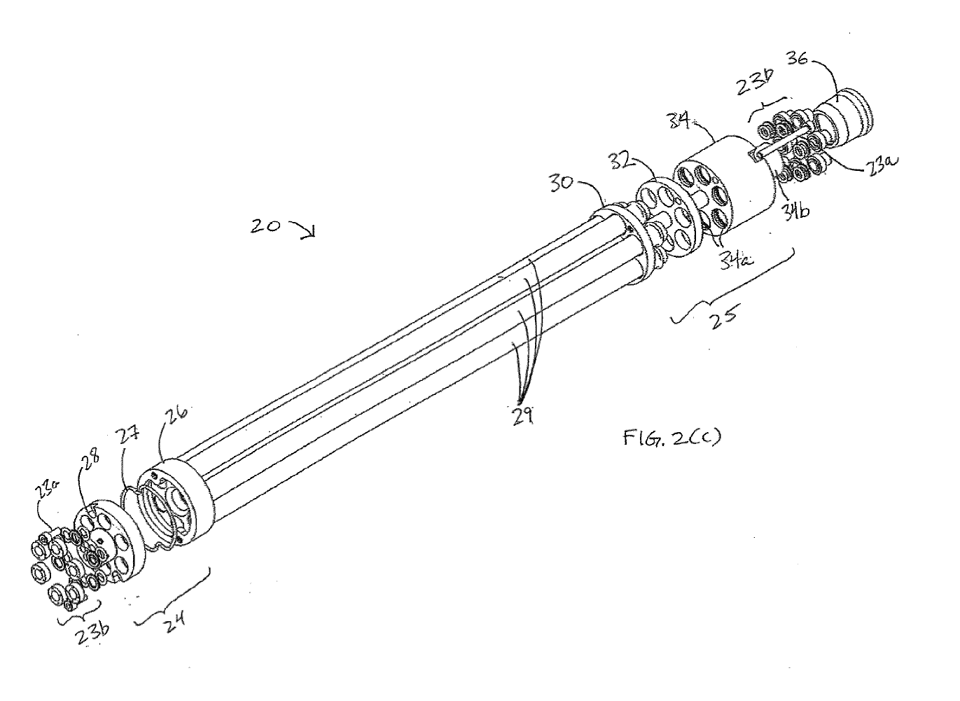

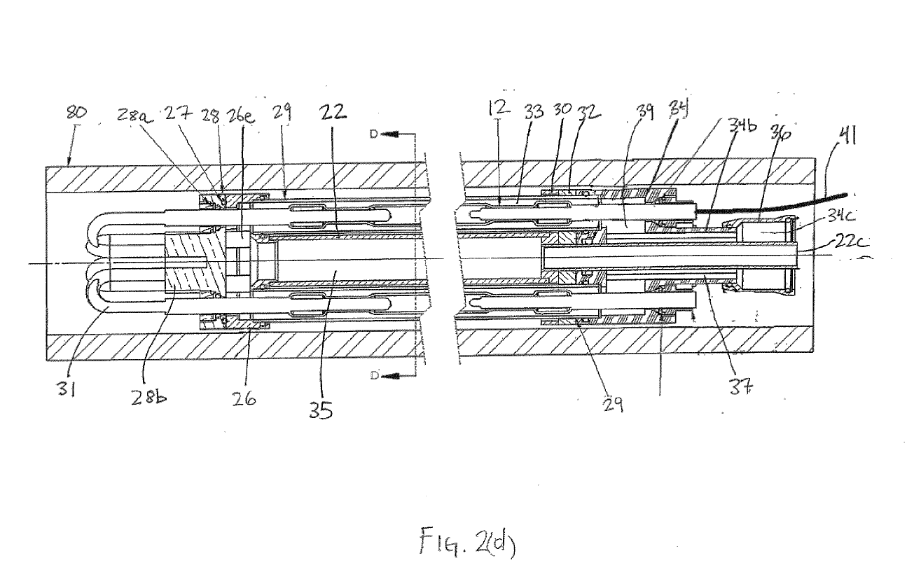

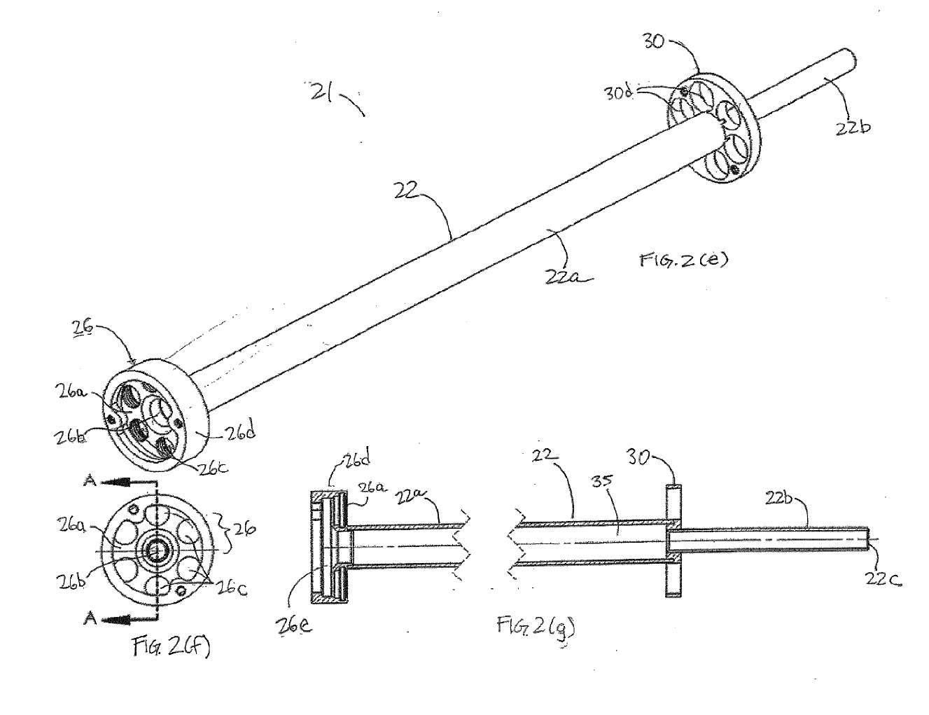

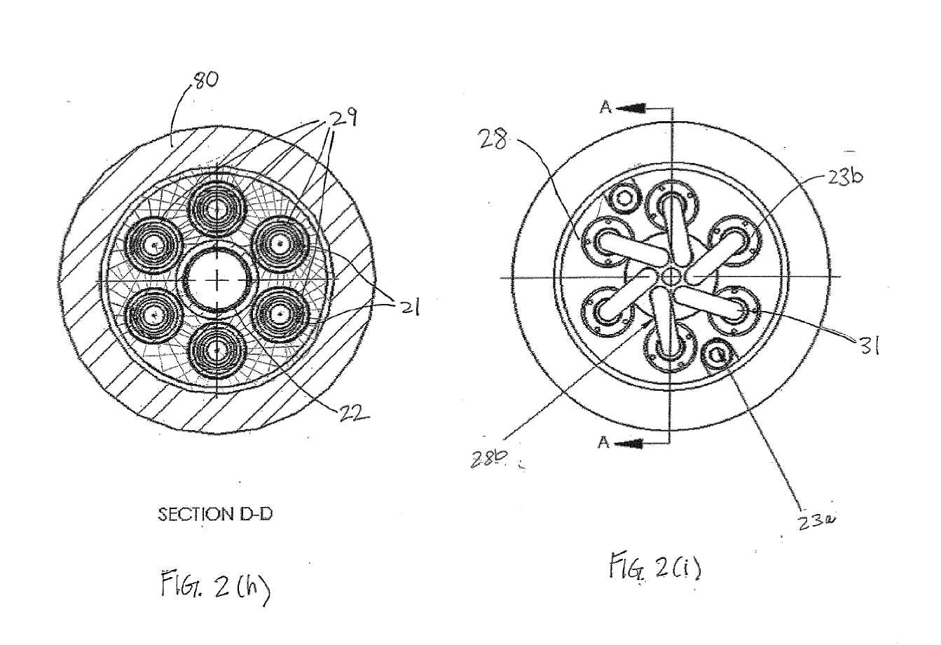

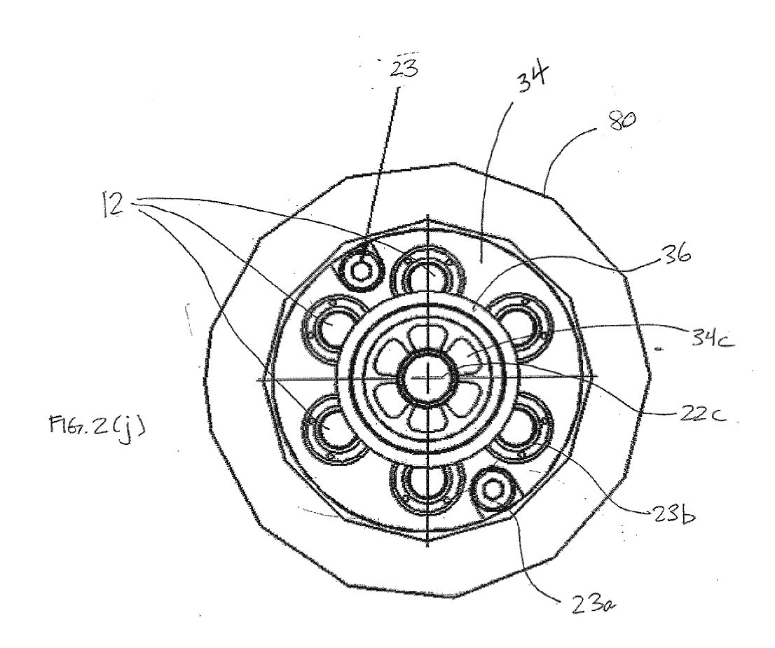

Referring to FIGS. 2(a) to (g), the processing head 20 comprises a support and cooling subassembly 21 and a plurality of plasma arc lamps 12 mounted on the support and cooling subassembly 21. Each plasma arc lamp 12 in this embodiment is a sealed gas type plasma arc lamp; however other plasma arc lamps or other comparable high intensity heat lamps could also be used. The sealed gas plasma arc lamp 12 comprises a tubular gas chamber and a first electrode (e.g. anode) and a second electrode (e.g. cathode) mounted at each end of the gas chamber such that the electrodes are spaced apart and facing each other inside the gas chamber. The gas chamber in this embodiment is composed of a quartz material and the electrodes are mounted to the gas chamber in such a manner that a gaseous seal is established inside the gas chamber; a pressurized gas such as xenon, argon, krypton, or neon is contained inside the gas chamber. A number of suitable plasma arc lamps of this design are commercially available and include those produced by Ushio and Heraeus. Such suitable and commercially available plasma arc lamps typically have a gap between the two electrodes of between 10 mm and 450 mm or more, and an internal pressure between 2 bar and 7 bar or more, and produce an output in the range of about 25 kW or more. Each plasma arc lamp operates by applying a sufficient electric potential across the electrodes to ionize the pressurized gas inside the quartz gas chamber, thereby generating electromagnetic radiation primarily in the infrared, visible and UV spectrums which radiate out of the plasma arc lamp and generate heat upon contact with the pipe 80 surface. The illustrated embodiment features six arc lamps 12 which are evenly spaced around the processing head 20; however, the heat treatment apparatus 10 can comprise a different number of arc lamps 21 depending on factors such as the diameter of the pipe 80 to be treated, desired thermal output, etc. The arc lamps 21 can be spaced evenly or unevenly around the processing head 20, so long as the distribution of arc lamps 21 around the processing head 20 is sufficient for the arc lamps 21 to collectively generate electromagnetic radiation that radiates radially outwards from the processing head 20 (“processing head radiation profile”); as can be seen in FIG. 2(h), the radiation emitted by each plasma arc lamp 21 (show as radially radiating rays in FIG. 2(h)) overlap with each other and collectively form a processing head radiation profile that reaches the entire circumference of the interior pipe surface 80. When heat treating the interior of cylindrical pipes, it is expected that three or more plasma arc lamps should be sufficient to enable the processing head 20 to produce a processing head radiation profile that comprises radiation that radiates in a generally radially outwards direction. More particularly, it is expected that three plasma arc lamps 21 spaced evenly around the processing head 20 will produce an individual radiation profile with sufficient overlap that the entire inner surface of a pipe will be treated. Rotation of the processing head 20 may still be useful to provide even and thorough heat treatment of the surface, whether the processing head 20 has three or more plasma arc lamps.

The central support and cooling subassembly 21 comprises a longitudinally extending and generally tubular coolant supply conduit 22 (see FIG. 2(e)), a pair of end cap assemblies (herein referred to as “distal end cap” 24, and “proximal end cap” 25) mounted at each end of the coolant supply conduit 22 and extending radially outwards from the central conduit 22, and a series of tubular coolant flow tubes 29 mounted to the end caps 24, 25 and extending longitudinally between the end caps 24, 25 and circumferentially around the coolant supply conduit 22. As can be seen in FIG. 2(c) and (d), the ends of each plasma arc lamp 12 are mounted to the end caps 24, 25 such that each plasma arc lamp 12 extends through a flow tube 29 and an annular channel 33 is defined between the outside surface of the plasma arc lamp 12 and the inside surface of the coolant flow tubes 29; this annular channel 33 serves as a heat exchange zone where coolant can flow past and cool the gas chamber wall (by absorbing heat) of the plasma arc lamp 12. Each coolant flow tube 29 is composed of a silicon dioxide [aka. silica or quartz] material or another material that is relatively transparent through the visible and near

UV and infrared spectrums to allow the radiation emitted by the ionized plasma to pass through and reach the pipe 80, and is sufficiently mechanically robust to withstand the thermal and mechanical stresses caused by operation of the heat treatment apparatus 10.

As can be seen in FIG. 2(e), the coolant supply conduit 22 comprises a pair of tubular sections (“first and second tubular sections” 22a, 22b) of different diameters that are physically and fluidly coupled together by a first flange 30 of the proximal end cap 25 (although the first flange 30 and flange base 26a are structurally integrated into the coolant supply conduit 22, the first flange 30 and flange base 26a function as part of the distal and proximal end caps 24, 25 and hereinafter will be described as being part of the assembly of components that form the end caps 24, 25). The inside of the coolant supply conduit 22 defines a coolant supply pathway 35 where a liquid coolant can flow from an inlet port 22c of the second tubular section 22b to the heat exchange zone 33 of each plasma arc lamp 12. The first tubular section 22a has a larger diameter than the second tubular section 22b and also serves as a structural member to support the plasma arc lamps 12 in the processing head 20.

The distal end cap 24 is mounted at a distal end of the first tubular section 22a and the proximal end cap 25 is mounted at a proximal end of the first tubular section 22a. The distal end cap 24 serves as a physical mount and an electrical grounding plate for an anode end of each plasma arc lamp 12, and as a coolant supply manifold for flowing coolant from the coolant supply conduit 22 into the heat exchange zone 33 of each plasma arc lamp 12. The proximal end cap 25 serves as a physical mount for a cathode end of each plasma arc lamp 12, as a cooling fluid discharge manifold for flowing coolant from the heat exchange zone 33 of each plasma arc lamp 12 out of the processing head 20, and as a mounting base that allows the connector 36 to connect the cooling coolant distribution assembly 50 to the processing head 20.

The distal end cap 24 is an assembly that comprises a cylindrical flange 26 and a cover 28 mounted to a rim end of the flange 26. The flange 26 comprises an annular flange base 26a mounted coaxially with the first tubular section 22a such that a central aperture 26b of the flange base 26a is aligned with a distal opening of the cooling supply conduit 22. The flange base 26a also has a plurality of arc lamp apertures 26c circumferentially spaced around the central aperture 26b. The distal ends of the flow tubes 29 are mounted to the distal end cap 24 such that the opening of each flow tube 29 aligns with an arc lamp aperture 26c. More particularly, the distal end of each flow tube 29 is inserted through a corresponding lamp aperture 26c and is fixed in place by an annular shoulder (as shown on FIG. 2(d)) on the flow tube 29 which abuts against the annular flange base 26a; an O-ring (shown on FIG. 2(d)) inside each arc lamp aperture 26c provides a liquid seal between the flange 26 and the flow tube 29. As can be most clearly seen in FIGS. 2(g) and 2(i), the flange 26 has a generally cylindrical portion 26d that extends perpendicularly from the outside edge of the flange base 26a and terminates with a circular rim end. The flange 26 is mounted to the coolant supply conduit 22 such that its rim end faces the distal direction. The distal end cap cover 28 is mounted to the rim end of the flange 26 by screws 23a; the interior space defined by the flange 26 and cover 28 is the cooling fluid supply manifold 26e. A seal 27 is located between the cover 28 and the flange 26 to establish a liquid seal for the cooling manifold 26e. The cover 28 comprises a plurality of arc lamp apertures 28a that line up with the arc lamp apertures 26c of the flange base 26a when the cover 28 is fastened to the flange 26 by screws 23a (as can be seen in FIG. 2(c)). The distal end of each plasma arc lamp 12 extends through each set of aligned arc lamp apertures 28a/26c and is secured to the flange 26 by a sealing nut, O-ring and washer (collectively referred to as “fasteners” 23b and shown in FIG. 2(c)). More particularly, the sealing nut is threaded on the outside and has a bore which receives the distal end of the plasma arc lamp 12, and when the sealing nut is screwed into the arc lamp aperture 28a the sealing nut causes the O-ring to push against the flange 26 thereby creating a liquid seal and holding the plasma arc lamp 12 in place.

The cover 28 also comprises an electrical connection terminal 28b protruding distally from a central part of the cover 28. Electrical conductor cables 31 electrically couple the anode end of each plasma arc lamp 12 to the electrical connection terminal 28b. The distal end cap 24, including the flange 26, cover 28 and fasteners 23 are composed of an electrically conductive material, thereby allowing the distal end cap 24 to serve as a grounding plate for the plasma arc lamps 12. Further, both tubular sections of the coolant supply conduit 22 and the flange 30 are composed of an electrically conductive material. As a result, a continuous electrical pathway is defined from the anode of each plasma arc lamp 12, through the grounding plate, and through the coolant supply conduit 22 to the proximal connector end of the processing head 20. As will be described in more detail below, the coolant distribution assembly 50 includes an electrically conductive pathway that is electrically coupled at one end to the continuous electrical pathway in the processing head 20 and at another to a ground, and a power supply (not shown) is electrically coupled to the cathode end of each plasma arc lamp 12, thereby creating an electrical circuit which upon application of current from the power supply, creates a voltage differential across the electrodes of each plasma arc lamp 12.

The proximal end cap 25 is an assembly that comprises the first flange 30, a heat shield 32, and a second flange 34 that are coaxially aligned and connected together by a pair of screws 23a. The first flange 30 is an annular plate having a central aperture and a plurality of arc lamp apertures 30d circumferentially spaced around the central aperture. The first flange 30 is attached to the first tubular section 22a such that the first flange's central aperture is in fluid communication with the coolant supply conduit 22, and the first flange's arc lamp apertures 30d are aligned with the arc lamp apertures of the distal end cap 24. Like the distal end cap 24, fasteners 23b are provided, each comprising a sealing nut, O-ring and washer, that serve to secure and establish a liquid seal between the proximal end of each plasma arc lamp 12 and the proximal end cap 25. The heat shield 32 is also an annular plate having a central aperture that is aligned with a proximal opening of the coolant supply conduit 22, as well as a series of arc lamp apertures circumferentially spaced around the central aperture and aligned with the arc lamp apertures 30d of the first flange 30. The heat shield 32 is composed of a ceramic or another material that can reflect or withstand a substantial amount of the radiation emitted by the plasma arc lamps 12. Finally, the second flange 34 is a generally cylindrical body comprising an axially extending central bore that is aligned with the proximal end of the coolant supply conduit 22 as well as a series of longitudinally extending arc lamp conduits 34a that are circumferentially spaced around the central bore and aligned with the arc lamp apertures of the heat shield 32 and the first flange 30. The second flange 34 also has a mounting tube 34b that extends longitudinally from a proximal end of the cylindrical body and which is aligned coaxially with the central bore. The second flange 34 can be composed of plastic, ceramic or other electrically non-conductive material.

The second tubular section 22b of the coolant supply conduit 22 extends longitudinally and coaxially through the second flange's mounting tube 34b; the interior diameter of the mounting tube 34b and the exterior diameter of the second tubular section 22b are selected so that an annular coolant return channel 37 is defined in between the mounting tube 34b and the second tubular section 22b and terminates at a coolant discharge port 34c. Part of the cylindrical body of the second flange 34 is hollow and serves as a coolant discharge manifold 39 for flowing returning coolant from the heat exchange zone 33 of each plasma art lamp 12 and out of the processing head 20 via the coolant return channel 37. The connector 36 is attached to the proximal end of the mounting tube 34b (“processing head connector end”) and is configured to releaseably couple to a connecting end of the coolant distribution and support assembly 50.

As can be seen in FIG. 2(c) and (j), a proximal end of the second flange 34 comprises a series of arc lamp apertures that are aligned with the arc lamp conduits 34a such that a cathode end of each arc lamp 12 protrudes from the proximal end cap 25. The distal and proximal end caps 24, 25 are configured so that the electrodes of the arc lamps 12 protrude from the end caps 24, 25 when installed on the support and cooling subassembly 21; this allows the cathode ends of the arc lamps 12 to be directly electrically coupled to the power supply (not shown) by power supply cables 41 and the anode ends of the arc lamps 12 to be electrically grounded via the aforementioned electrical pathway through the processing head 20 and cooling fluid distribution assembly 50. To avoid a short circuit, the cathode end of each arc lamp 12 is electrically isolated from any part of the electrically grounding pathway, and in particular, is electrically isolated from the first flange 30. The fasteners 23b at the proximal end cap 25 and the second flange 34 are electrically insulating, and the flow tube quartz wall and flow of deionized water also electrically insulate the cathode from the first flange 30.

When the plasma arc lamps 12 are installed, a coolant pathway is defined through the processing head 20, starting at the coolant supply conduit 22, to the coolant supply manifold 26e in the distal end cap 24, through the heat exchange zone 33 of each plasma arc lamp 12, through the coolant discharge manifold 39 in the proximal end cap 25, and then through the coolant return channel 37.

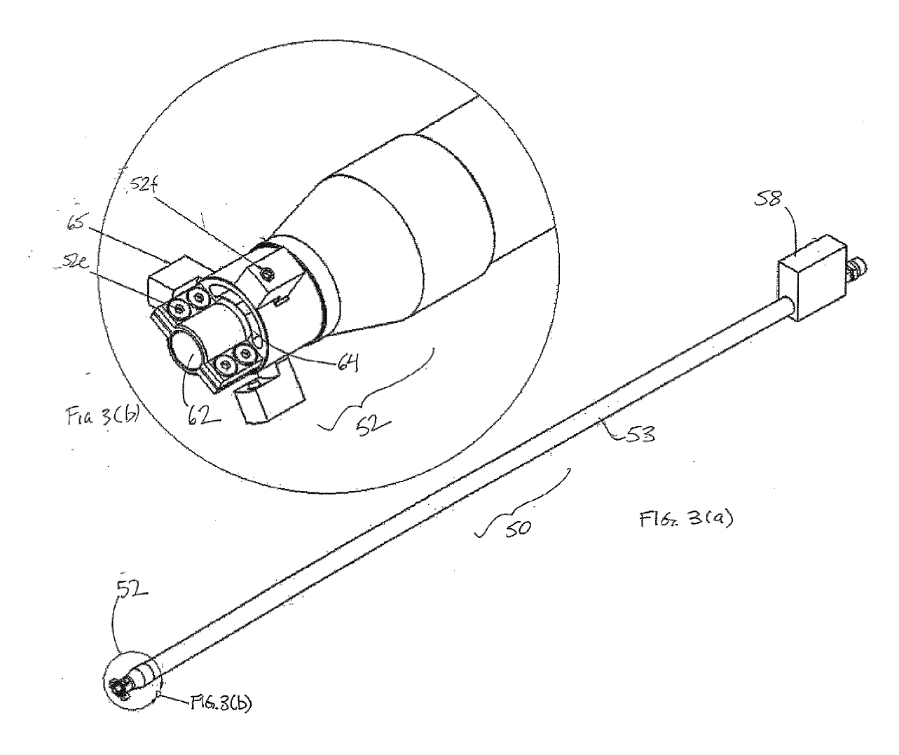

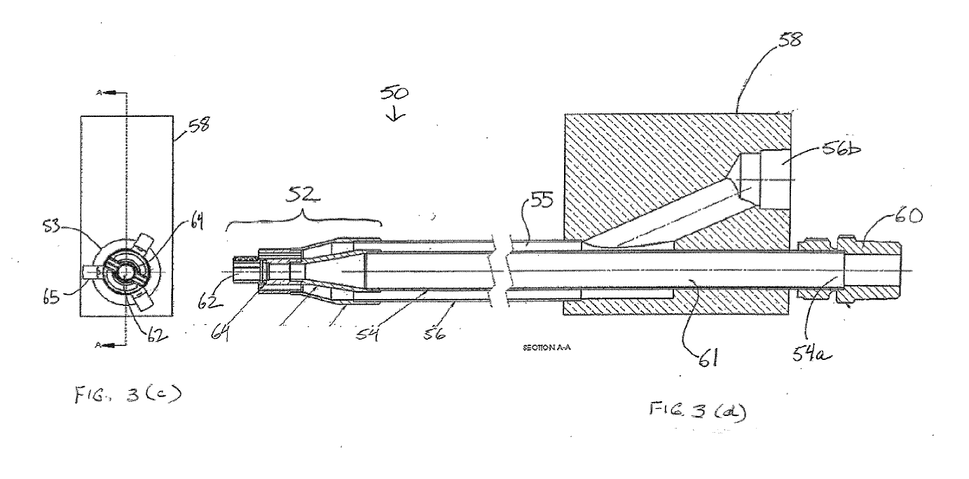

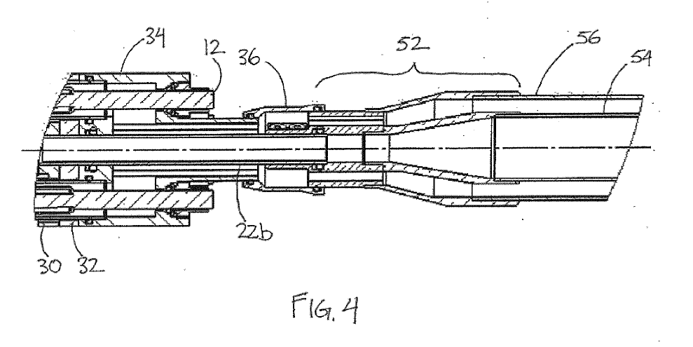

Referring now to FIGS. 3(a) to (c), coolant distribution and support structure 50 comprises an elongated support member 53 comprising a pair of coaxially aligned and longitudinally extending tubes, namely an inner tube 54 and an outer tube 56. The inside of the inner tube 54 defines a coolant supply conduit 61 and the diameters of the respective inner and outer tubes 54, 56 are selected such that an annular coolant return conduit 55 is defined therebetween. The coolant supply conduit 61 has a coolant inlet 54a at the proximal end of the support member 53 that is fluidly couplable to a coolant supply (not shown) through a fitting 60. A connector subassembly 52 is located at the distal end of the support member 53 and is configured to engage the processing head's connecting end, and be coupled thereto by the connector 36. The connector subassembly 52 comprises a coolant supply port 62 in fluid communication with the coolant supply conduit 61, a coolant return port 64 in fluid communication with the coolant return conduit 55, as well as radially protruding blocks 65 each provided with a threaded hole with a set screw 52f which engages with a sloped surface of connector 36. The second tubular section 22b is insertable into port 62 and secured by screw clamp 52e thereby connecting the processing head 20 and coolant distribution and support structure 50 together. When connected, the coolant supply port 62 is in fluid communication with the coolant supply port 22c and the coolant return port 64 is in fluid communication with the coolant discharge port 34c. The connector 36 is releasable so that the processing head 20 can be easily replaced or interchanged.

The coolant distribution and support structure 50 further comprises a distribution block 58 that serves as a base that provides structural support to the support member 53 and comprises a coolant discharge manifold that is fluidly coupled to the coolant return conduit 55 and has a coolant discharge port 56b for discharging spent coolant from the apparatus 10.

The inner tube 54 is composed of an electrically conductive material to provide a continuous electrical grounding pathway from a ground to the anode ends of the plasma arc lamps 12 when the processing head 20 is attached to the support assembly 50. For example, the distribution block 58 may be electrically grounded, which in turn grounds the inner tube 54, conduit 22, distal cap 24 and the anode ends of the plasma arc lamps 12. A voltage can then be applied to the second electrodes of the heat lamps 12 to activate the heat lamps 12 and generate heat.

The diameter of the distal and proximal end caps 24, 25 and the mounting position of the coolant flow tubes 29 on the end caps 24, 25 are selected to conform to the inner diameter of the pipe 80, i.e. the end cap diameters are selected to be smaller than the pipe inner diameter, and the flow tube mounting positions should allow the plasma arc lamps 12 to be located in close proximity to the pipe inner surface, and be spaced evenly around the pipe inner surface. This configuration is elected to enable the processing head 20 to apply heat all around the pipe inner surface. The length of the plasma arc in the lamps 12 can be selected to be at least as long as the length of the pipe inner surface to be treated, such that the processing head 20 can apply heat to the entire pipe inner surface without longitudinal translation relative to the pipe.

In this embodiment, the coolant flow tubes 29 are arranged circumferentially around the central cooling and support subassembly 21, which enables the processing head 20 be particularly suited for heat treating cylindrical surfaces, since the longitudinally extending and circumferentially arranged plasma arc lamps 12 follow the contour of a cylindrical surface. Alternatively, the coolant flow tubes 29 can be arranged around the central cooling and support subassembly 21 in a different configuration, such as a square, oval, triangular, or polygonal configuration. The different configuration can be selected to follow the contours of the inside surface to be treated; for example, if an enclosed structure has a longitudinal cavity with a square cross section, the processing head 20 can be configured with the flow tubes 29 extending around the coolant supply conduit 22 in a square pattern to follow the contours of the inner surface of the enclosed structure.

As noted above, the anode ends of each arc lamp 12 are grounded and the cathode ends of each arc lamp 12 are electrically coupled to a power source. The power source is set at an output that creates sufficient ionization reaction in the plasma arc lamps 12 to produce the required heat treatment of the pipe 80. In order to cool the plasma arc lamps 12 and prevent overheating, the coolant supply inlet 54a is fluidly coupled to a fluid supply source (e.g. a tank outlet, radiator, or water supply), and the coolant discharge port 56b is fluidly coupled to a fluid return source (e.g. a tank inlet or a drain). Coolant can then be flowed across the heat exchange zone 33 of each plasma arc lamp 12. Excess heat produced by the plasma arc lamps 12 is absorbed into the coolant on its return path through the apparatus 10 and to the fluid return source. The heated coolant can cooled and recirculated, or disposed. Coolant can be continuously flowed over the plasma arc lamps 12 to maintain a desired temperature level while treating the pipe 80, or intermittently flowed over the plasma arc lamps 12 as needed to reduce temperature levels.

Optionally, the flow tubes 29 are provided with a reflective coating (not shown) on a part of its surface to direct radiation generated by the plasma arc lamps 21 in the flow tubes 29 in a radially outwards direction and towards the surface of the pipe 80. More particularly, the reflective coating can be cover a lengthwise segment on each flow tube 29 that is between the plasma arc lamp 21 and the central conduit 22. In another alternative embodiment, the central conduit 22 itself can be provided with a reflective coating that serves to reflect radiation generated by the plasma arc lamps in a radially outwards direction. The flow tubes 29 can also be replaced by a single flow tube (not shown) that provides a single coolant channel between the distal and proximal caps 24, 25 to simultaneously cool all of the plasma arc lamps 12 at once.

Accordingly, the embodiments described herein disclose a processing head 20 that can be used for thermal treatment of small hollow substrates such as small diameter pipes and tubes. The heat lamp housing 20 arranges plasma arc lamps 12 in close proximity, and in a circumferential array that conforms to the shape of a curved substrate such as a pipe. An internal coolant pathway is also provided in order to cool the plasma arc lamps 12 to prevent overheating and allow for continuous operation.

While particular embodiments have been described in the foregoing, it is to be understood that other embodiments are possible and are intended to be included herein. It will be clear to any person skilled in the art that modifications of and adjustments to the foregoing embodiments, not shown, are possible. The scope of the claims should not be limited by the preferred embodiments set forth in the examples, but should be given the broadest interpretation consistent with the description as a whole.

What is claimed is:

1. A heat treatment apparatus for heat treating an inner surface of a longitudinally extending cavity of a target structure, comprising:
a processing head comprising
a longitudinally extending central support member, distal and proximal end caps protruding laterally from the central support member, and a plurality of elongated plasma arc lamps each mounted to the end caps such that the plasma arc lamps extend longitudinally along and are positioned laterally around the central support member such that radiation emitted collectively by the plasma arc lamps is directed generally radially outwards from the processing head; and
a coolant pathway having heat exchange zones in thermal communication with the plasma arc lamps and coolant supply and return conduits in fluid communication with the heat exchange zones.

2. A heat treatment apparatus as claimed in claim 1 further comprising a coolant distribution assembly coupled to the processing head and comprising a coolant supply conduit in fluid communication with the coolant supply conduit of the processing head, and a coolant return conduit in fluid communication with the coolant return conduit of the processing head.

3. A heat treatment apparatus as claimed in claim 2 further comprising a connector releasably coupling the processing head to the coolant distribution assembly.

4. A heat treatment apparatus as claimed in claim 1 wherein the target structure is a cylindrical pipe and the plasma arc lamps are mounted to the end caps such that the plasma arc maps are laterally positioned laterally around the central support member in a circular array.

5. A heat treatment apparatus as claimed in claim 4 wherein the plasma arc lamps are evenly spaced around the circular array.

6. A heat treatment apparatus as claimed in claim 5 comprising at least three plasma arc lamps evenly spaced around the circular array.

7. A heat treatment apparatus as claimed in claim 6 wherein each plasma arc lamp is a sealed gas type plasma arc lamp.

8. A heat treatment apparatus as claimed in claim 1 wherein the processing head further comprises a plurality of flow tubes each mounted to and extending between the end caps and around one plasma arc lamp, and wherein each heat exchange zone is an annular channel defined by an interior surface of a flow tube and the exterior surface of a plasma arc lamp inside the flow tube.

9. A heat treatment apparatus as claimed in claim 8 wherein the coolant supply conduit extends through the central support member, the coolant pathway further comprises a coolant supply manifold inside the distal end cap and in fluid communication with an outlet end of the coolant supply conduit and an inlet end of each of the annular channels, and a coolant discharge manifold inside the proximal end cap and in fluid communication with an outlet end of each of the annular channels and the coolant return conduit.

10. A heat treatment apparatus as claimed in claim 8 wherein at least one of the flow tubes comprises a reflective coating positioned to reflect radiation generated by the plasma arc lamp inside the at least one flow tube in a radial outwards direction from the processing head.

11. A heat treatment apparatus for heat treating an interior surface of a longitudinally extending cavity of a target structure, comprising:
a processing head comprising:
a longitudinally extending central support member, distal and proximal end caps protruding laterally from the central support member, each end cap having a plurality of apertures configured to respectively receive distal and proximal ends of elongated plasma arc lamps and position the plasma arc lamps to extend longitudinally along and laterally around the central support member such that radiation emitted collectively by the plasma arc lamps is directed generally radially outwards from the processing head; and
a coolant pathway having heat exchange zones in thermal communication with the plasma arc lamps and coolant supply and return conduits in fluid communication with the heat exchange zones.

12. A heat treatment apparatus as claimed in claim 11 further comprising a coolant distribution assembly coupled to the processing head and comprising a coolant supply conduit in fluid communication with the coolant supply conduit of the processing head, and a coolant return conduit in fluid communication with the coolant return conduit of the processing head.

13. A heat treatment apparatus as claimed in claim 12 further comprising a connector releasably coupling the processing head to the coolant distribution assembly.

14. A heat treatment apparatus as claimed in claim 11 wherein the target structure is a cylindrical pipe and wherein the plurality of apertures of the distal and proximal end caps are configured in a circular array such that the plasma arc lamps extend laterally around the central support member in a circular array.

15. A heat treatment apparatus as claimed in claim 14 wherein the plurality of apertures of the distal and proximal end caps are evenly spaced around the circular array.

16. A heat treatment apparatus as claimed in claim 15 wherein the distal and proximal end caps each comprise at least three apertures for receiving at least three plasma end caps.

17. A heat treatment apparatus as claimed in claim 1 wherein the processing head further comprises a plurality of flow tubes each mounted to and extending between the end caps and around one plasma arc lamp, and wherein each heat exchange zone is an annular channel defined by an interior surface of a flow tube and the exterior surface of a plasma arc lamp inside the flow tube.

18. A heat treatment apparatus as claimed in claim 17 wherein the coolant supply conduit extends through the central support member, the coolant pathway further comprises a coolant supply manifold inside the distal end cap and in fluid communication with an outlet end of the coolant supply conduit and an inlet end of each of the annular channels, and a coolant discharge manifold inside the proximal end cap and in fluid communication with an outlet end of each of the annular channels and the coolant return conduit.

19. A heat treatment apparatus as claimed in claim 17 wherein at least one of the flow tubes comprises a reflective coating positioned to reflect radiation generated by the plasma arc lamp inside the at least one flow tube in a radial outwards direction from the processing head.
